(19) United States
(12) Patent Application Publication
(10) Pub. No.: US 2015/0084934 A1
(43) Pub. Date: Mar. 26, 2015

(54) ELECTROMAGNETIC AND CAPACITIVE POINTER

(71) Applicant: WALTOP INTERNATIONAL CORPORATION, HSINCHU CITY (TW)

(72) Inventor: YU CHIEHMR HO, Hsinchu City (TW)

(73) Assignee: WALTOP INTERNATIONAL CORPORATION, HSINCHU CITY (TW)

(21) Appl. No.: 14/149,672

(22) Filed: Jan. 7, 2014

(30) Foreign Application Priority Data
Sep. 23, 2013 (TW) 102134184

(51) Int. Cl. G06F 3/0354; G06F 3/044

(52) U.S. Cl. CPC G06F 3/03545; G06F 3/044
USPC 345/179

(57) ABSTRACT

An electromagnetic and capacitive pointer is disclosed. The electromagnetic and capacitive pointer comprises a tube assembly and a conductive tube assembly, a ferrite core, an non-magnetic and conductive pin, a control circuit board, a conductive pin holder, a conductive elastomer, a holder and a power source. The non-magnetic and conductive pin, the conductive pin holder, the conductive elastomer, the control circuit board and the conductive tube assembly constitute a conductive path.

### FIELD OF THE INVENTION

The present invention relates to a pointer, and more particularly to an electromagnetic and capacitive pointer.

### DESCRIPTION OF THE PRIOR ART

Electromagnetic-type input technology applies electromagnetic pens and the input device with induction sensor coils. Electromagnetic pen has advantages of convenient for writing, tip pressure level function, and certain sensing height. Although electromagnetic type input technology has advantages of convenient for writing, tip pressure level function, and certain sensing height as mentioned above, an user's finger(s) or other touch sources will not work and a particular stylus must be used for input operation. Capacitive touch input technology has been widely applied in touch panel. Capacitive touch input technology has advantages of allowing the use of variety of touch sources such as an user's finger(s) for input operation and multi-touch gestures for various operations and functions. Various applications can be assigned corresponding to multi-touch gestures. Thus integrating both electromagnetic and capacitive input technologies into a touch panel will have both advantages thereof and significantly increase convenience of use.

In order to perform input operation on a touch panel with electromagnetic and capacitive input functions, a pointer with electromagnetic and capacitive functions must be used. Therefore, the invention provides an electromagnetic and capacitive pointer to meet the requirement of using a pointer on a touch panel with electromagnetic and capacitive input functions.

### SUMMARY OF THE INVENTION

An object of the present invention is to provide an electromagnetic and capacitive pointer with both electromagnetic and user hand held capacitive input functions to meet the requirement of using a pointer on a touch panel with electromagnetic and capacitive input functions.

According to the object, one embodiment of the present invention provides an electromagnetic and capacitive pointer comprising a tube assembly and a conductive tube assembly, a ferrite core, an non-magnetic and conductive pin penetrating trough the ferrite core and being moveable through the ferrite core, a control circuit board, a conductive pin holder, a conductive elastomer located between the conductive pin holder and the control circuit board, a holder with a winding coil electrically connecting to the control circuit board to constitute a resonance circuit with the ferrite core, and a power source providing the control circuit board with electrical power. One end of the non-magnetic and conductive pin is sheathed in the conductive pin holder. The ferrite core, the conductive pin holder and the conductive elastomer are sheathed in the holder. The non-magnetic and conductive pin, the conductive pin holder, the conductive elastomer, the control circuit board and the conductive tube assembly constitute a conductive path.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1A shows an electromagnetic and capacitive pointer according to one embodiment of the invention.

FIG. 1B is a sectional view of the electromagnetic and capacitive pointer shown in FIG. 1A.

FIG. 1C is an exploded view of the electromagnetic and capacitive pointer shown in FIG. 1A and FIG. 1B.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the scale of each component may not be expressly exactly.

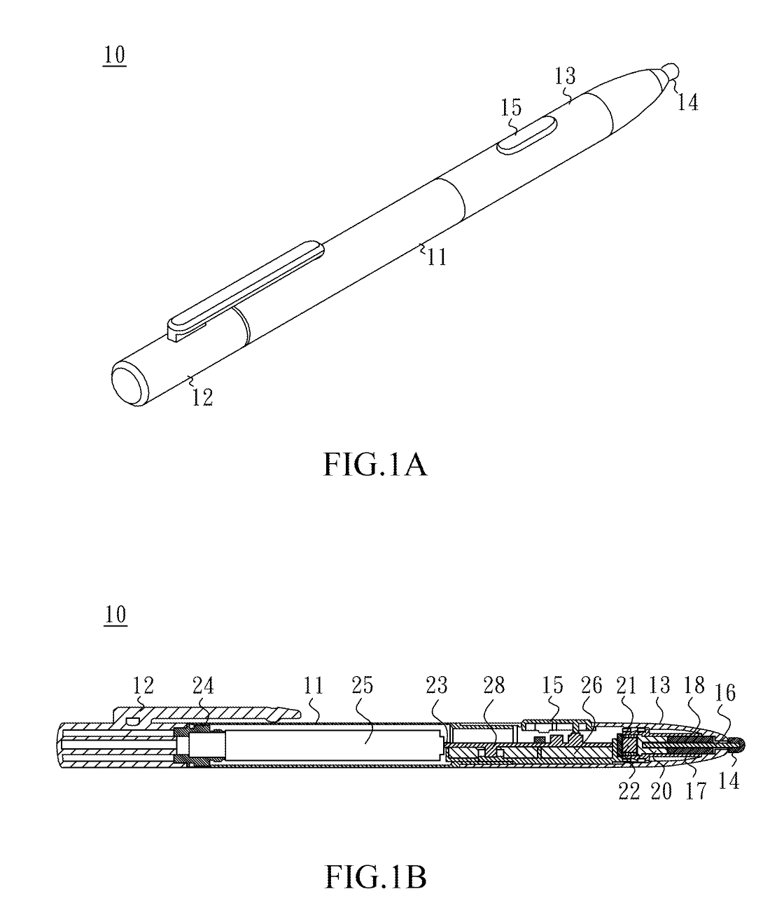

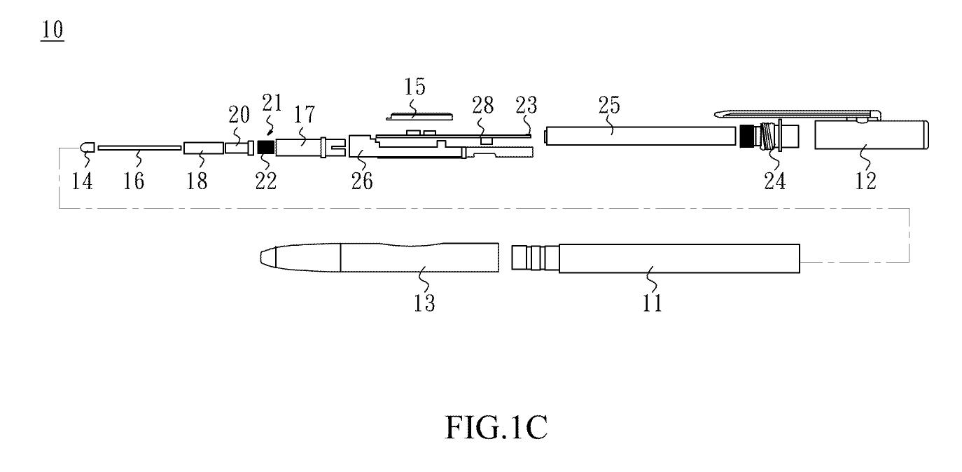

FIG. 1A shows an electromagnetic and capacitive pointer according to one embodiment of the invention. The electromagnetic and capacitive pointer 10 comprises tube assemblies 12 and 13, a conductive tube assembly 11, a pen tip 14 and a button 15. The electromagnetic and capacitive pointer 10 of this embodiment will be further described in detail with FIG. 1B and FIG. 1C.

FIG. 1B is a sectional view of the electromagnetic and capacitive pointer shown in FIG. 1A. The electromagnetic and capacitive pointer 10 further comprises an non-magnetic and conductive pin 16 or a conductive pin with a low permeability p, a ferrite core 18, an non-magnetic and conductive pin holder 20 or a conductive pin holder with a low permeability p, a spring 21, a conductive elastomer 22, holders 17 and 26, a control circuit board 28, a power source 25 and a cathode assembly 24 beside the tube assemblies 12 and 13, the conductive tube assembly 11, the pen tip 14 and the button 15. The control circuit board 28 has a conductive anode contact or a conductive elastic strip 23. The cathode assembly 24 comprises a conductive elastic strip. The conductive elastic strip 23 and the cathode assembly 24 contact the power source 25. A circuit board can be located between the conductive elastomer 22 and the control circuit board 28 so as to electrically connect the conductive elastomer 22 and the control circuit board 28. The circuit board comprises a printed circuit board.

The tube assemblies 12 and 13 comprise non-conductive tube assemblies while the conductive tube assembly 11 comprises a tube assembly of conductive material or a tube assembly with inner and outer conductive plated surfaces. The pen tip 14 comprises a rubber pen tip or a conductive pen tip. The non-magnetic and conductive pin 16 comprises a conductive pin of non-magnetic metal materials such as stainless steel. The conductive elastomer 22 comprises a conductive rubber. The control circuit board 28 comprises a printed circuit board with a resonance circuit and components thereon so that the electromagnetic and capacitive pointer can resonate with the electromagnetic signals from sensor coils or antennas of a touch panel. The power source 25 comprises a battery to provide the control circuit board 28 with electrical power.

FIG. 1C is an exploded view of the electromagnetic and capacitive pointer shown in FIG. 1A and FIG. 1B. The tube assemblies 12 and 13, the conductive tube assembly 11 constitute a hollow assembly to accommodate the non-magnetic and conductive pin 16, the ferrite core 18, the non-magnetic and conductive pin holder 20, the spring 21, the conductive elastomer 22, the holders 17 and 26, the control circuit board 28, the power source 25 and the cathode assembly 24.

The ferrite core 18 and a coil (not shown) winding the holder 17 constitute an inductor and the coil electrically connects to the control circuit board 28 through a conductive wire (not shown) to complete a resonance circuit. The ferrite core 18 has a hollow center and a diameter slightly larger than that of the non-magnetic and conductive pin 16 so that the non-magnetic and conductive pin 16 can move through the center of the ferrite core 18.

One end of the non-magnetic and conductive pin 16 contrary to the tip is sheathed in the non-magnetic and conductive pin holder 20. The conductive elastomer 22 is sheathed in the spring 21 and both are located between the non-magnetic and conductive pin holder 20 and the control circuit board 28. The non-magnetic and conductive pin holder 20 contacts the conductive elastomer 22. The ends of the ferrite core 18 and the non-magnetic and conductive pin 16 contrary to the tip and the non-magnetic and conductive pin holder 20 are sheathed in the holder 17. The control circuit board 28 is sheathed in the holder 26. The non-magnetic and conductive pin 16, the conductive pin holder 20, the conductive elastomer 22, the control circuit board 28 and the conductive tube assembly 11 constitute a conductive path. When an user uses the electromagnetic and capacitive pointer 10 to contact or approach the surface of a touch panel, the user (fingers), the conductive tube assembly 11 and the touch panel constitute a conductive path through the conductive path mentioned above so as to perform input operation.

The electromagnetic and capacitive pointer in one embodiment of the invention has both electromagnetic and user hand held capacitive input functions to meet the requirement of using a pointer on a touch panel with electromagnetic and capacitive input functions.

Although specific embodiments have been illustrated and described, it will be appreciated by those skilled in the art that various modifications may be made without departing from the scope of the present invention, which is intended to be limited solely by the appended claims.

What is claimed is:

1. An electromagnetic and capacitive pointer, comprising:
a tube assembly and a conductive tube assembly;
a ferrite core;
an non-magnetic and conductive pin penetrating trough the ferrite core and being moveable through the ferrite core;
a control circuit board;
a conductive pin holder, one end of the non-magnetic and conductive pin being sheathed in the conductive pin holder;
a conductive elastomer located between the conductive pin holder and the control circuit board;
a holder with a winding coil electrically connecting to the control circuit board to constitute a resonance circuit with the ferrite core, the ferrite core, the conductive pin holder and the conductive elastomer being sheathed in the holder; and
a power source providing the control circuit board with electrical power;
wherein the non-magnetic and conductive pin, the conductive pin holder, the conductive elastomer, the control circuit board and the conductive tube assembly constitute a conductive path.

2. The electromagnetic and capacitive pointer according to claim 1, wherein the conductive tube assembly comprises a tube assembly of conductive material or a tube assembly with inner and outer conductive plated surfaces.

3. The electromagnetic and capacitive pointer according to claim 1, wherein the non-magnetic and conductive pin comprises a conductive pin of non-magnetic metal material.

4. The electromagnetic and capacitive pointer according to claim 1, wherein the conductive elastomer comprises a conductive rubber.

5. The electromagnetic and capacitive pointer according to claim 1 further comprising a spring and the conductive elastomer being sheathed in the spring.

6. The electromagnetic and capacitive pointer according to claim 1, wherein a circuit board is located between the conductive elastomer and the control circuit board.

7. The electromagnetic and capacitive pointer according to claim 1, wherein the power source comprises a battery.

8. The electromagnetic and capacitive pointer according to claim 1, wherein the control circuit board comprises a conductive anode contact or a conductive elastic strip.

9. The electromagnetic and capacitive pointer according to claim 1 further comprising a cathode assembly comprising a conductive elastic strip.

10. The electromagnetic and capacitive pointer according to claim 1, wherein the electromagnetic and capacitive pointer is used on a touch panel.
